(19) United States
(12) Patent Application Publication
(10) Pub. No.: US 2026/0198474 A1
(43) Pub. Date: Jul. 16, 2026

(54) BARK BEETLE TRAP WITH A DAMAGING DEVICE THAT DAMAGES THE BARK BEETLES BY MEANS OF DIELECTRIC-BARRIER DISCHARGES

(71) Applicant: Hochschule für angewandte Wissenschaft und Kunst Hildesheim/Holzminden/Göttingen, Hildesheim (DE)

(72) Inventors: Wolfgang Rohe, Bovenden (DE); Wolfgang Viöl, Adelebsen (DE)

(21) Appl. No.: 19/444,403

(22) Filed: Jan. 9, 2026

(30) Foreign Application Priority Data
Jan. 10, 2025 (EP) 25 151 108.5

(51) Int. Cl. A01M 1/22; A01M 1/02

(52) U.S. Cl. CPC A01M 1/223; A01M 1/02; A01M 2200/012

(57) ABSTRACT

A bark beetle trap (1) comprises a housing (2) with entry slots (3), an attraction device releasing volatile attractants in the housing, a size selection device (17) at the bottom of the housing, and a damaging device (19) arranged below the size selection device and comprising a high-voltage electrode (21) and a counter-electrode (23) at a free distance (24), and a high-voltage source applying a high voltage between the electrodes (21, 23). At least one of the electrodes is provided with a dielectric barrier (22). The high-voltage source varies the high voltage applied between the electrodes so quickly that dielectric-barrier electrical discharges are caused between the electrodes, that kill bark beetles getting into the area of the free distance between the electrodes, or at least damage them to such an extent that they are no longer able to move in a coordinated manner.

### CROSS REFERENCE TO RELATED APPLICATIONS

This application claims priority to European Patent Application No. EP 25 151 108.5 entitled “Borkenkäferfalle mit einer die Borkenkäfer durch dielektrisch behinderte Entladungen schädigenden Schädigungseinrichtung”, filed on Jan. 10, 2025, the entire disclosure of which is hereby incorporated herein in its entirety.

### FIELD OF THE INVENTION

The invention generally relates to a bark beetle trap. More particularly, the invention relates to a bark beetle trap comprising a housing with entry slots, an attraction device that releases volatile attractants in the housing, a size selection device arranged at the bottom of the housing, and a damaging device arranged below the size selection device.

Catching and killing bark beetles with bark beetle traps is a measure to reduce the infestation of trees with bark beetles, that threatens the population, to such an extent that at least the risk of damage to fundamentally healthy trees by bark beetles is minimized.

The invention relates to a bark beetle trap that is suitable for the bark beetle species spruce ips (Ips typographus), the slightly smaller bark beetle species Pityogenes chalcographus and other bark beetle species.

### BACKGROUND OF THE INVENTION

A bark beetle trap comprising the features of the preamble of independent patent claim 1 is known from German utility model DE 20 2023 000 706 U1. The damaging device of the known bark beetle trap is a high-voltage killing device. The size selection device comprises a sorting slot. Bark beetles pass through the sorting slot into a counting area of a counting unit, for example in the form of a photoelectric sensor. The photoelectric sensor is a part of a device for switching the high-voltage killing device on and off, when bark beetles are detected. The photoelectric sensor not only switches the high-voltage killing device on and off, but also counts the bark beetles passing through the sorting slot. The high-voltage killing device is used to kill the bark beetles by means of high voltage. In the high-voltage killing device, for example, a pulsed high voltage is applied between conductor tracks whose distance from each other is so great that no current can flow between the conductor tracks. If a bark beetle gets between the conductor tracks or touches both conductor tracks, it connects them electrically by means of a flashover, which generates an electric arc that kills the bark beetle without using poison. In the high-voltage killing device, in addition to adjacent conductor tracks, high-voltage electrodes can be arranged opposite each other, to which such a high voltage is applied that a bark beetle is killed by the arc that forms when the bark beetle falls between the high-voltage electrodes. In any case, the bark beetles killed by an electric arc are charred. On the one hand, charring releases odorous substances that can deter other bark beetles. On the other hand, the charred bark beetles cannot serve as food for bark beetle antagonists, which are also referred to as “predators” below. In the known bark beetle trap, a collection container collects the charred bark beetles. In addition, the energy required to kill each bark beetle with an electric arc is high, and each electric arc places considerable strain on the high-voltage killing device, which means that a long service life cannot be expected.

There still is a need of a more efficient bark beetle trap.

### SUMMARY OF THE INVENTION

The present invention relates to a bark beetle trap. The bark beetle trap comprises a housing with a bottom and entry slots above the bottom, an attraction device configured for releasing volatile attractants in the housing, a size selection device arranged at the bottom of the housing, and a damaging device arranged below the size selection device and including a high-voltage electrode, a counter-electrode arranged at a free distance from the high-voltage electrode, and a high-voltage source applying a high voltage between the high-voltage electrode and the counter-electrode. At least one of the high-voltage electrode or the counter-electrode is provided with a dielectric barrier adjoining the free distance. The high-voltage source is configured to vary the high voltage applied between the high-voltage electrode and the counter-electrode so quickly that electrical discharges, that, due to the dielectric barrier, are dielectric-barrier discharges, are generated between the high-voltage electrode and the counter-electrode. Bark beetles getting into an area of the free distance between the high-voltage electrode and the counter-electrode are damaged by means of the dielectric-barrier discharges between the high-voltage electrode and the counter-electrode at least to such an extent that the bark beetles are no longer able to move in a coordinated manner.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a partially transparent front view of a bark beetle trap.

FIG. 2 is an also partially transparent side view of the bark beetle trap of FIG. 2.

FIG. 3 is a perspective view of a housing of the bark beetle trap of FIGS. 1 and 2, wherein an end wall of the housing has been removed to reveal an interior of the housing.

FIG. 4 is a section through the housing of the bark beetle trap of FIGS. 1 to 3; and

FIG. 5 is a perspective view of another embodiment of the bark beetle trap.

### DETAILED DESCRIPTION

A bark beetle trap according to the present disclosure comprises a housing with entry slots, an attraction device that releases volatile attractants in the housing, a size selection device arranged at the bottom of the housing, and a damaging device arranged below the size selection device. The damaging device comprises a high-voltage electrode, a counter-electrode arranged at a free distance from the high-voltage electrode, and a high-voltage source applying a high voltage between the high-voltage electrode and the counter-electrode. At least one of the high-voltage electrode and the counter-electrode is provided with a dielectric barrier. The high-voltage source varies the high voltage applied between the high-voltage electrode and the counter-electrode so quickly that electrical discharges are caused between the high-voltage electrode and the counter-electrode, that, due to the dielectric barrier, are dielectric-barrier discharges. The dielectric-barrier discharges at least occur when a bark beetle enters the area of the free distance between the high-voltage electrode and the counter-electrode. Then, the dielectric-barrier discharges occur across the bark beetle. In any case, bark beetles that enter the area between the high-voltage electrode and the counter-electrode are killed by the electrical discharges between the high-voltage electrode and the counter-electrode, or at least damaged to such an extent that they are no longer able to move in a coordinated manner.

In a dielectric-barrier discharges, the electrical energy introduced per discharge filament is at least a factor of 10 smaller than in a pulsed arc discharge due to the currents flowing for only a few nanoseconds. However, even these small discharge energies are sufficient to kill bark beetles, even if their death does not necessarily occur immediately, i.e., during the respective electrical discharge, or at least to damage them to such an extent that they are no longer able to move in a coordinated manner, so that they can no longer damage trees, even if they escape from the bark beetle trap. In addition, the dielectric-barrier discharges between the high-voltage electrode and the counter-electrode can ignite and maintain a cold atmospheric pressure plasma in the area of the free distance between the electrodes. Reactive species form in this cold atmospheric pressure plasma, which, like the electrical discharges themselves, have a high lethal potential for bark beetles entering their area. However, the bark beetle trap according to the present disclosure not only comprises a significantly higher efficiency, i.e., low consumption of electrical energy to kill or at least substantially damage one bark beetle, and a longer service life than a high-voltage killing device that forms arcs, but also a considerably reduced hazard potential. In particular, if the high-voltage electrode is provided with a dielectric barrier, larger living creatures may get into contact with the high-voltage electrode without any risk of injury due to the limitation of the flowing currents, even if these creatures are grounded.

The high-voltage source of the damaging device according to the present disclosure can exploit the fact that the voltage required for dielectric-barrier discharges decreases with increasing speed of the variation in high voltage between the high-voltage electrode and the counter-electrode. Due to the low electrical power required, a high-voltage source capable of quick voltage build-up can be implemented cost-effectively.

In the bark beetle trap according to the present disclosure, the high-voltage electrode and the counter-electrode can be aligned parallel to each other and run at a small angle of typically less than 20° and preferably less than 10° to the vertical. The bark beetles passing through the selection device can thus fall or slide down between the high-voltage electrode and the counter-electrode, where they are killed or at least substantially damaged.

In order to achieve such free falling or sliding through of the bark beetles without at the same time requiring a high voltage to cause the dielectric-barrier electric discharges, the free distance between the high-voltage electrode and the counter-electrode can be in a range of 2.5 mm to 10 mm. Preferably, it is in a range of 3 mm to 6 mm.

An open bark beetle ejection opening may be arranged below the high-voltage electrode and the counter-electrode. In other words, the bark beetle trap according to the present disclosure may comprise a downwardly open damaging device. Even if larger creatures get into contact with the high-voltage electrode in the presence of an active high-voltage source, there is no risk of injury at the bark beetle ejection opening because the electrical power is greatly limited by the dielectric barrier. The downward-opening damaging device has the advantage that dead or at least substantially damaged bark beetles simply fall out and do not accumulate in the bark beetle trap and decay there. The typical maintenance work of emptying the trap is no longer necessary and there is no decay odor, which in turn would attract additional bark beetle enemies into the trap. A further advantage is that the bark beetles are killed or at least substantially damaged by the damaging device of the bark beetle trap according to the present disclosure, but that they are not charred, for example. The bark beetles that are only killed and, in particular, those that are only damaged can be eaten by predators without risk of harm and serve as valuable food for them.

In the bark beetle trap according to the present disclosure, a further counter-electrode may be arranged at a further free distance on the rear side of the high-voltage electrode facing away from the counter-electrode, wherein at least one of the high-voltage electrode and the further counter-electrode is provided with a dielectric barrier for dielectric-barrier electrical discharges between the high-voltage electrode and the further counter-electrode. Also here, the dielectric barrier is preferably provided at least on the high-voltage electrode in order to directly shield the high voltage applied thereto. Alternatively, a further high-voltage electrode may be arranged at a further free distance on a rear side of the counter-electrode, wherein at least one of the counter-electrode and the further high-voltage electrode is provided with a dielectric barrier for dielectric-barrier electrical discharges between the counter-electrode and the further high-voltage electrode. This dielectric barrier is also preferably arranged at least on the high-voltage electrode. In both of the above alternatives, the damaging device comprises a second passage from below the selection device through the further free distance, which can end below the high-voltage electrode and the counter-electrode at a further open bark beetle ejection opening or at the same bark beetle ejection opening as the first passage.

Even if the potential hazard posed by the applied high voltage is only present for small creatures such as bark beetles due to the dielectric barrier, the damaging device of the bark beetle trap according to the present disclosure may be enclosed by an external electrical insulation.

In order to activate the damaging device only when a bark beetle that has not yet been killed or at least substantially damaged actually enters the area of the high-voltage electrode and the counter-electrode, a photoelectric sensor can be arranged between the size selection device and the damaging device, and the high-voltage source can be controlled depending on a signal from the photoelectric sensor.

The size selection device of the bark beetle trap according to the present disclosure is to be designed in such a way that it allows bark beetles, but not their predators, to pass through to the damaging device. A maximum passage width in the range of 2.0 mm to 2.1 mm has proven to be appropriate for this purpose. This corresponds to the maximum diameter of large European spruce bark beetles. All bark beetles can pass through openings of this width. Their predators, such as the ant-colored beetle, cannot. A perforated plate with a large number of passage holes of a defined diameter proves to be particularly efficient as a size selection device for the bark beetle trap according to the present disclosure. Bark beetles particularly like circular passage holes because they correspond to their natural behavior of boring into the bark of a tree as soon as possible after landing. Book printers are also parasitized by parasitic wasps. However, these do not pursue the bark beetles into the boreholes or into the perforated plate, i.e., they do not need to be size-selected by the perforated plate in order to leave the bark beetle trap flying.

The attractant device of the bark beetle trap according to the present disclosure may comprise an attractant release body in the housing, for example made of a sponge-like material impregnated with a liquid solution of the attractant. Alternatively or additionally, the attractant device may comprise a barrel which holds attractant-releasing material and which can be closed except for a pipe leading into the housing. The attractant-releasing material may, for example, be wood of such a type and in such a condition that it releases attractants which are particularly attractive to bark beetles. The attractants emitted from the wood enter the housing via the conduit and thus lure the bark beetles into the housing. The attractants with which the sponge-like attractant-releasing body is impregnated may be, in particular, pheromones that attract bark beetles. The use of such pheromones in bark beetle traps is generally known.

To make it easier for the bark beetle's predators to get out of the housing again once they have entered through the entry slots, the inner surface of the housing below the entry slots can be roughened and/or covered with sand paper. The bark beetle's predators can thus climb up the inner surface of the housing and leave it again through the entry slots. Bark beetles that have entered the housing, on the other hand, tend to burrow, i.e., penetrate the holes in the perforated plate.

In an embodiment, the housing of the bark beetle trap comprises a plurality of individual compartments. A shaft with smooth walls may then be connected between each of the individual compartments of the housing and the centrally arranged damaging device of the bark beetle trap. All bark beetles that pass through a part of the size selection device arranged at the bottom of the respective compartment fall into the respective shaft and through the shaft into the central damaging device. The several compartments of the housing may, for example, be arranged in a star-shaped fashion around a central post.

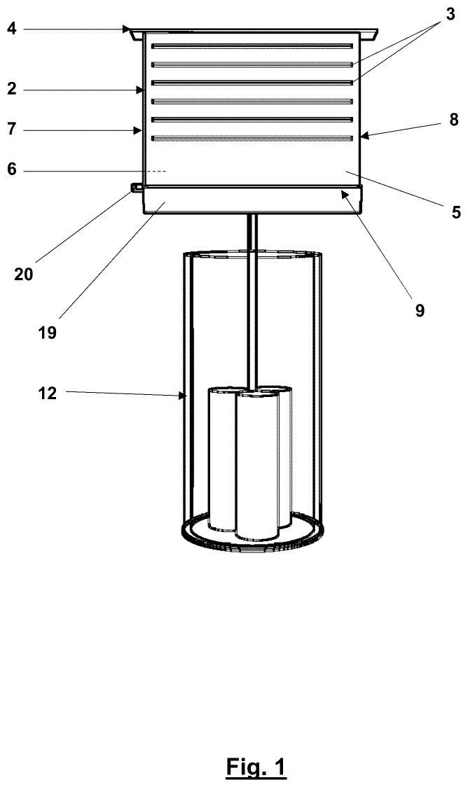

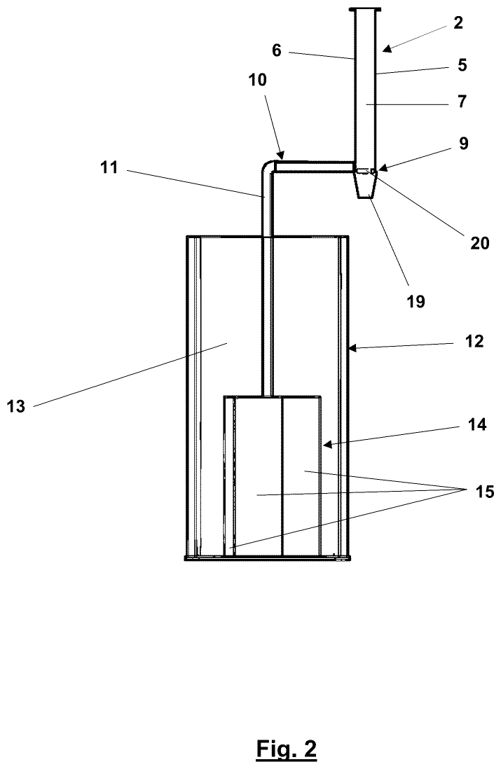

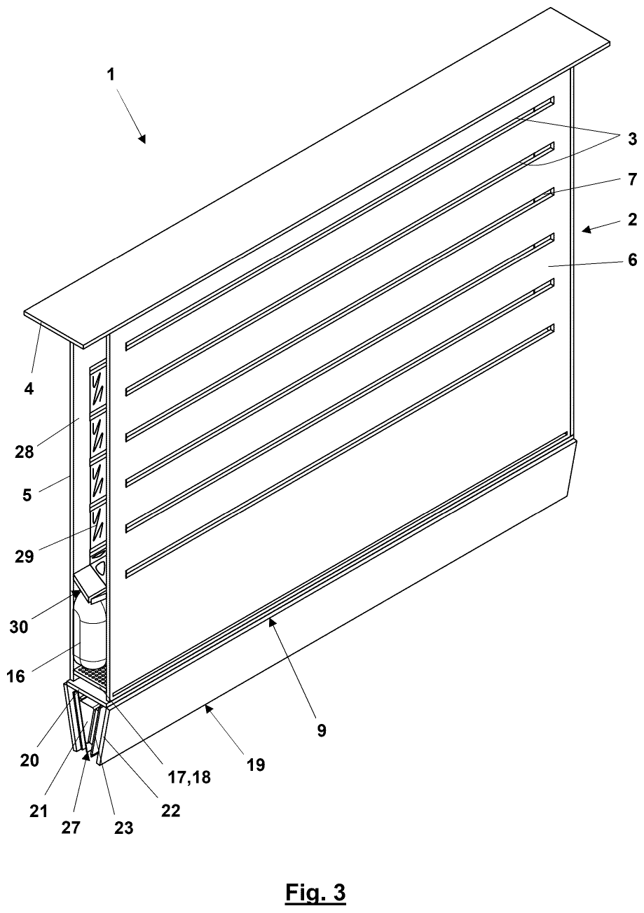

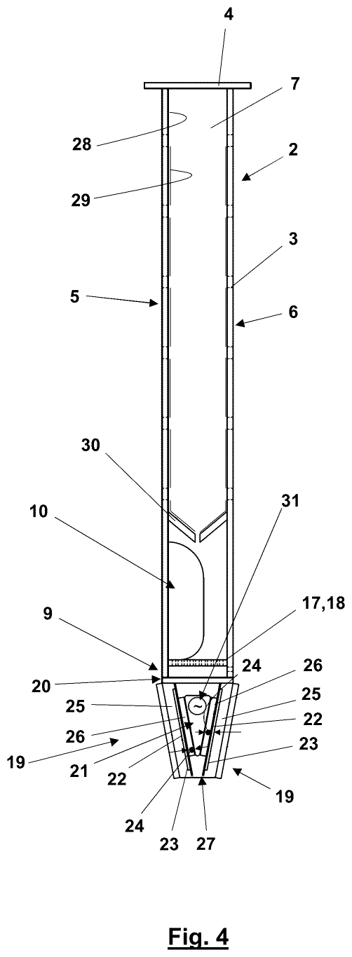

Now referring in greater detail to the drawings, the bark beetle trap 1 shown in FIG. 1 and FIG. 2 comprises a housing 2 with entry slots 3, which is shown separately in FIG. 3 and FIG. 4. The housing 2 comprises a slightly protruding roof 4, side walls 5 and 6 in which the entry slots 3 are formed, and closed end walls 7 and 8. An attractant diffusor 10 is connected on the side in the area of the bottom 9 of the housing 2. The attractant diffusor 10 is connected via an attractant line 11 to an otherwise hermetically sealed barrel 12. Inside 13 of the barrel 12 are attractant-releasing materials 14, for example pieces of wood 15, which comprise a high content of volatile scents that attract bark beetles, such as (−)α-pinene or (+)-limonene. The volatile scents released from these pieces of wood 15 enter the housing 2 through the attractant line 11 and the attractant diffusor 10. Furthermore, a sponge-like attractant-releasing body 16 is arranged in the housing 2 above the bottom 9 and below a capture funnel 30. The capture funnel can comprise an opening width that is limited such that it serves as a size preselection device for bark beetles.

As shown in FIG. 3 and FIG. 4, a size selection device 17 in the form of a perforated plate 18 with a plurality of vertically extending circular through holes with a diameter of 2.1 mm is arranged at the bottom 9 of the housing. A photoelectric sensor 20 is formed below the size selection device 17 and above a damage detection device 19. The photoelectric sensor 20 detects when a bark beetle passes through the size selection device 17, i.e., a through hole in the perforated plate 18, and thus enters the damaging device 19. The photoelectric sensor 20 then controls a high-voltage source (not shown) of the damaging device 19. A central, wedge-shaped high-voltage electrode 21 and counter-electrodes 23 of the damaging device 19, each provided with a dielectric barrier 22, are connected to the high-voltage source. The dielectric barriers 22 of the counter-electrodes arranged in a V-configuration are located at free distances 24 from the central high-voltage electrode 21. The counter-electrodes are enclosed in an electrical insulation 25 on the outside. When a quickly varying high voltage is applied between the high-voltage electrode 21 and the counter-electrodes 23, which may be at earth or ground potential, a cold atmospheric pressure plasma 26 is ignited in the area of the free distances 24. The atmospheric pressure plasma 26 kills, or rather the reactive species contained therein kill, bark beetles that enter the area of the free distances 24, or at least damage them substantially. Alternatively or additionally, the dielectric barrier 22 of the high-voltage electrode 21 causes dielectric-barrier electrical discharges between the high-voltage electrode 21 and the counter-electrodes 23 via bark beetles located in the area of the free distances 24. These discharges also have the desired effect of killing bark beetles or at least causing them substantial damage. The quickly varying high voltage between the high-voltage electrode 21 and the counter-electrodes 23, which is applied to the damaging device 19 of the bark beetle trap 1 by the high-voltage source 31 schematically depicted in FIG. 4, comprises a typical amplitude of several kilovolts. The damaging device 19 ends at the bottom with an open bark beetle ejection opening 27, through which the bark beetles that have been killed or at least damaged to such an extent that they are no longer able to move in a coordinated manner fall out of the damaging device 19. Below the entry slots 3, an inner surface 28 of the housing 2 may be roughened or covered with sand paper 29 to make it easier for bark beetle predators to climb back out of the housing 2 through the entry holes 3.

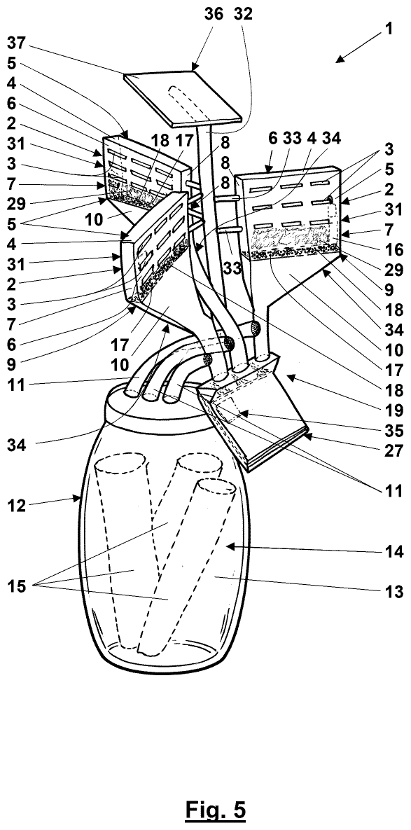

In the embodiment of the bark beetle trap 1 depicted in FIG. 5, the housing 2 comprises three separate compartments 31 each comprising a part of the size selection device 17 at the bottom 9. The three compartments 31 are arranged in a star-shaped fashion around a central post 32. The compartments 31 are mounted to the central post 32 via holding arms 33 radially extending from the central post 32. The compartments 31 of the housing 2 are connected to the centrally arranged damaging device 19 via shafts 34 with smooth inner walls. Bark beetles that pass through the parts of the size selection device 17 drop through the respective shaft 34 into the damaging device 19. The shafts 34 include the attractant diffusors 10 connected to the compartments 31. The attractant lines 11 coming from the barrel 12 enter into the shafts 34, but the entrances of the attractant lines 11 into the shafts 34 are blocked in a suitable way by, for example a mesh or gauze, such that no bark beetles may get into the attractant lines 11 and the barrel 12. Generally, the damaging device 19 according to FIG. 5 may be designed like that one according to FIGS. 3 and 4. FIG. 5 schematically indicates that the damaging device is controlled by a controller 35 and powered by a power source 36 comprising a solar module 37. The compartments 31 arranged in the star-shaped fashion around the central post 32 cover all wind directions in which bark beetles may be blown towards the bark beetle trap 1.

Many variations and modifications may be made to the preferred embodiments of the invention without departing substantially from the spirit and principles of the invention. All such modifications and variations are intended to be included herein within the scope of the present invention, as defined by the following claims.

We claim:

1. A bark beetle trap comprising
a housing with a bottom and entry slots above the bottom,
an attraction device configured for releasing volatile attractants in the housing,
a size selection device arranged at the bottom of the housing, and
a damaging device arranged below the size selection device and including a high-voltage electrode, a counter-electrode arranged at a free distance from the high-voltage electrode, and a high-voltage source applying a high voltage between the high-voltage electrode and the counter-electrode,
wherein at least one of the high-voltage electrode or the counter-electrode is provided with a dielectric barrier adjoining the free distance, and
wherein the high-voltage source is configured to vary the high voltage applied between the high-voltage electrode and the counter-electrode so quickly that electrical discharges, that, due to the dielectric barrier, are dielectric-barrier discharges, are generated between the high-voltage electrode and the counter-electrode, bark beetles getting into an area of the free distance between the high-voltage electrode and the counter-electrode being damaged by means of the dielectric-barrier discharges between the high-voltage electrode and the counter-electrode at least to such an extent that the bark beetles are no longer able to move in a coordinated manner.

2. The bark beetle trap of claim 1, wherein the high-voltage source is configured to vary the high voltage applied between the high-voltage electrode and the counter-electrode so quickly that
the dielectric-barrier discharges are ignited across bark beetles located between the high-voltage electrode and the counter-electrode, and/or
a cold atmospheric pressure plasma is ignited between the high-voltage electrode and the counter-electrode.

3. The bark beetle trap of claim 1, wherein the high-voltage electrode and the counter-electrode are aligned parallel to each other and run at an angle of less than 20° to the vertical.

4. The bark beetle trap of claim 1, wherein the high-voltage electrode and the counter-electrode are aligned parallel to each other and run at an angle of less than 10° to the vertical.

5. The bark beetle trap of claim 1, wherein the free distance between the high-voltage electrode and the counter-electrode is in a range from 2.5 mm to 10 mm.

6. The bark beetle trap of claim 1, wherein the free distance between the high-voltage electrode and the counter-electrode is in a range from 3 mm to 6 mm.

7. The bark beetle trap of claim 1, wherein an open bark beetle discharge opening is arranged below the high-voltage electrode and the counter-electrode.

8. The bark beetle trap of claim 1, wherein a further counter-electrode is arranged on a rear side of the high-voltage electrode facing away from the counter-electrode at a further free distance, wherein at least one of the high-voltage electrode or the further counter-electrode is provided with a further dielectric barrier for dielectric-barrier discharges between the high-voltage electrode and the further counter-electrode.

9. The bark beetle trap of claim 1, wherein a further high-voltage electrode is arranged on a rear side of the counter-electrode facing away from the high-voltage electrode at a further free distance, wherein at least one of the counter-electrode or the further high-voltage electrode is provided with a further dielectric barrier for dielectric-barrier discharges between the counter-electrode and the further high-voltage electrode.

10. The bark beetle trap of claim 1, wherein the damaging device is enclosed by an outer electrical insulation.

11. The bark beetle trap of claim 1, wherein a photoelectric sensor is arranged between the size selection device and the damaging device, and wherein the high-voltage source is controlled depending on a signal provided by the photoelectric sensor.

12. The bark beetle trap of claim 1, wherein the size selection device comprises a maximum passage width in a range from 2.0 mm to 2.1 mm.

13. The bark beetle trap of claim 1, wherein the size selection device comprises a perforated plate with a plurality of through holes.

14. The bark beetle trap of claim 1, wherein the attraction device comprises an attractant dispensing body in the housing.

15. The bark beetle trap of claim 1, wherein the attraction device comprises a barrel configured for accommodating attractant-releasing material and for being closed except for an attractant line opening into the housing.

16. The bark beetle trap of claim 1, wherein an inner surface of the housing below the entry slots is roughened.

17. The bark beetle trap of claim 1, wherein an inner surface of the housing below the entry slots is covered with sand paper.

18. The bark beetle trap of claim 1, wherein the housing has a plurality of compartments, wherein each of the compartments of the plurality of compartments comprises a part of the size selection device at the bottom, and wherein a shaft with smooth walls is interposed between each of the compartments of the plurality of compartments and the damaging device.

19. The bark beetle trap of claim 18, wherein the plurality of compartments is arranged in a star-shaped fashion.

20. The bark beetle trap of claim 18, wherein the compartments of the plurality of compartments are arranged around a central post and mounted to the central post.
